(19) United States
(12) Patent Application Publication
(10) Pub. No.: US 2006/0244663 A1
(43) Pub. Date: Nov. 2, 2006

(54) Compact, multi-element antenna and method

(75) Inventors: Rod G. Fleck, Bellevue, WA (US); Robert J. Hill, Prunedale, CA (US)

Correspondence Address: Edward W. Bulchis, Esq.;DORSEY & WHITNEY LLP, Suite 3400, 1420 Fifth Avenue, Seattle, WA, 98101, US

(73) Assignee: Vulcan Portals, Inc.

(21) Appl. No.: 11/118,005

(22) Filed: Apr. 29, 2005

(51) Int. Cl. H01Q 1/38; H01Q 1/24

(52) U.S. Cl. 343/700 MS; 343/702

(57) ABSTRACT

An antenna is specially adapted for a portable electronic device, such as a hand-held computer or cell phone, having a conductive metal housing surrounding a radio transceiver. A rectangular recess is formed in one surface of the housing, and an elongated printed circuit board is placed along an inner wall of the housing. A coaxial cable coupled to the transceiver enters the housing, and an outer shield of the cable is connected to the inner wall of the housing along a substantial length of the cable. A center conductor of the cable is connected to a conductive layer of the printed circuit board. The recess is enclosed by a window that is substantially transparent to RF energy. RF energy radiated from the printed circuit board is capacitively coupled to a sheet of conductive material, and the RF energy is then radiated from the conductive sheet.

### FIELD OF THE INVENTION

This invention relates to antennas, and, more particularly, an antenna that is suitable for use with a portable device having a conductive metal case in which the antenna is housed.

### BACKGROUND OF THE INVENTION

A wide variety of portable devices are provided with wireless capabilities using either infra-red or radio transceivers. For example, portable personal computers and personal digital assistants (“PDA's”) may have IEEE-802.11 WiFi or “Wi-Fi” communication capabilities. Cellular telephones are another common example of portable devices using radio transceivers. In such devices, an antenna is required to transmit and receive radio signals. The most common types of antennas used in such devices are variations of a dipole antenna. In a basic dipole antenna 10 as shown in FIG. 1, a radio frequency (“RF”) signal is applied between two “legs” 14, 16 of the dipole antenna. However, the basic dipole antenna 10 is generally not sufficiently compact to be useable in portable electronic devices such as PC's, PDA's and cellular telephones. For this reason, dipole antennas for use with portable electronic devices of the type shown in FIG. 2 have evolved into a dipole antenna 20 in which a first leg 24 is substantially identical to the legs 14, 16 shown in FIG. 1. However, a second leg of the antenna 20 is implemented using a printed circuit board 26 used in the electronic device that is typically enclosed by a housing 28. Conductive traces on the printed circuit board 26 thus form one of the legs of the antenna 20.

The antenna 20 provides satisfactory performance in a wide variety of applications. However, the leg 24 is longer than is desirable since it must project from the housing 28 a substantial distance. To address this problem, the antenna 20 has been modified by shorting one end of the leg 24 to the printed circuit board 26, and coupling a lead to leg 24 at an intermediate location between the shorted end and the other end. As is well known in the art, the impedance of either a shorted or an open circuited antenna varies like that of a transmission line from zero ohms to infinite ohms. For example, the impedance between an antenna leg and a printed circuit board is zero ohms at the shorted end, but infinite ohms at the other end if the length of the leg is one-quarter wavelength of the applied RF signal. At some location between the ends, the impedance will be a desired value, such as 50 ohms, and it is at this location that a lead is connected to the antenna leg.

The leg 24 of the antenna 20 is essentially linear because the conductor used to form the leg 24 is essentially a wire. A planar version of that design is a planar inverted F antenna (“PIFA”) 30 of the type shown in FIG. 3. The PIFA design again uses a printed circuit board 32 as one of the legs of the antenna 30. The other leg of the antenna 30 is formed by a conductive plate 34 having one of its edges 36 bent downwardly and shorted to the printed circuit board 32. A center conductor 40 of a coaxial cable 42 is connected to the plate 34 at an intermediate location between the shorted edge 36 and an opposite edge 38, which is preferably spaced one-quarter wavelength from the edge 36. The coaxial cable 42 extends through the printed circuit board 32, and an outer shield 44 of the coaxial cable 42 is connected to the printed circuit board. The printed circuit board 32 and plate 34 are surrounded by a housing 48. As can be seen in FIG. 3, the plate 34, the bent edge 36, and the center conductor 40 together resemble an upside down “F,” which gives the antenna its “inverted F” name. The greater surface area of the plate 34 used in the PIFA antenna 30 allows the antenna to transmit more power compared to the linear leg 24 used in the antenna 22 of FIG. 2.

In a modification of the PIFA antenna 30, the bent edge 36 may be eliminated, and the plate 34 is not shorted to the printed circuit board 32. As shown in FIG. 4, a modified PIFA antenna 50 includes a conductive rectangular plate 54 having a length of one-half wavelength. As mentioned above, the impedance of an open circuited antenna varies like that of a transmission line from zero ohms to infinite ohms. Neither end of the plate 54 is shorted to the printed circuit board 32. As a result, the impedance between the plate 54 and the printed circuit board is infinite at each end, and substantially zero ohms in the center. At some location between the ends of the plate 54, the impedance will be a desired value, such as 50 ohms, and it is at this location that the center conductor 40 is connected to the plate 54.

The modified dipole antenna 20 shown in FIG. 2, the PIFA antenna 30 shown in FIG. 3, and the modified PIFA antenna 50 shown in FIG. 4 provide satisfactory performance in a wide variety of applications. They can provide this performance because the housings surrounding the antennas 20, 30, 50 are generally made of plastic, which is transparent to radio waves. However, there is a need for some portable electronic devices to be in conductive metal housings, generally because metal housings can be thinner, sturdier and more attractive. As is well known in the art, an antenna surrounded by a conductive metal housing is incapable of radiating RF energy outside the housing since the housing acts essentially as a Faraday cage. As a result, antennas used in portable electronic devices having metal housings are generally placed outside of the housing, and they are surrounded by a cover of plastic or other RF transparent material. Placing the antenna and cover outside the housing undesirably increases the external dimensions of the electronic device, and it may adversely affect the attractiveness of its appearance. Furthermore, if one leg of the antenna is placed outside the housing, the other leg of the housing, which is generally formed by a printed circuit board, will be inside the housing. As a result, all of the RF energy radiated by the printed circuit board will remain inside the housing. In conventional antennas 30, 50 of the type shown in FIGS. 3 and 4, respectively, 80 percent or more of the radiated energy can be radiated by the printed circuit board 32. A conductive housing surrounding the printed circuit board thus significantly reduces the gain and efficiency of the antenna.

There is therefore a need for an efficient, high-gain antenna that can be placed inside a conductive housing of an electronic device so that the external dimensions of the electronic device are not undesirably increased by the antenna.

### SUMMARY OF THE INVENTION

An antenna is specially adapted for use in a portable electronic device having a radio transceiver mounted in a conductive metal housing. A recess having a conductive inner wall and four side walls is formed in the housing along at least one of its surfaces. A driven element is positioned along the inner wall of the recess. According to one aspect, the driven element is a rectangular printed circuit board having a length that is one-half wavelength at the operating frequency of the radio transceiver. According to another aspect, the driven element is a rectangular printed circuit board having one of its ends shorted to the inner wall of the recess and a length that is one-quarter wavelength at the operating frequency of the radio transceiver. A coaxial cable connected to the radio transceiver enters the recess and extends along a conductive wall of the recess. The coaxial cable has a shield connected to the conductive wall of the recess along at least some of the portion of the coaxial cable extending along the conductive wall of the recess. As a result, current is coupled from the shield of the coaxial cable to the housing, thereby causing the housing to emit RF energy. The coaxial cable also has a center conductor connected to the driven element. The recess is enclosed by a planar window that is fabricated from a material that is transparent to RF energy. A conductive radiating element is carried by the planar window at a location causing RF energy coupled to the driven element to be capacitively coupled to the radiating element. RF energy is then radiated from the radiating element.

### BRIEF DESCRIPTION OF THE DRAWINGS

FIG. 1 is a schematic diagram of a basic dipole antenna of conventional design.

FIG. 2 is a schematic diagram of a modified dipole antenna of conventional design that is relatively compact.

FIG. 3 is a schematic diagram of a planar inverted F antenna of conventional design.

FIG. 4 is a schematic diagram of a modified planar inverted F antenna of conventional design.

FIG. 5 is an isometric view of a hand-held computer containing an antenna according to one example of the invention.

FIG. 6 is an exploded isometric view of the antenna of FIG. 5.

FIG. 7 is a cross-sectional view of the antenna of FIG. 5.

FIG. 8 is a plan view of the antenna of FIG. 5.

FIG. 9 is a cross-sectional view of an antenna according to another example of the invention.

FIG. 10 is a block diagram of the computer shown in FIG. 5.

FIG. 11 is a block diagram of a cellular telephone containing an antenna according to one example of the invention.

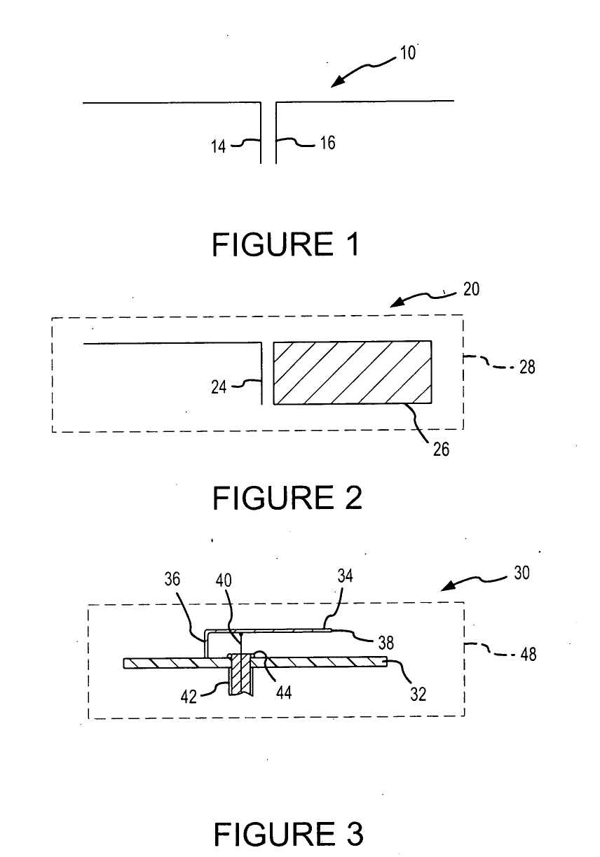

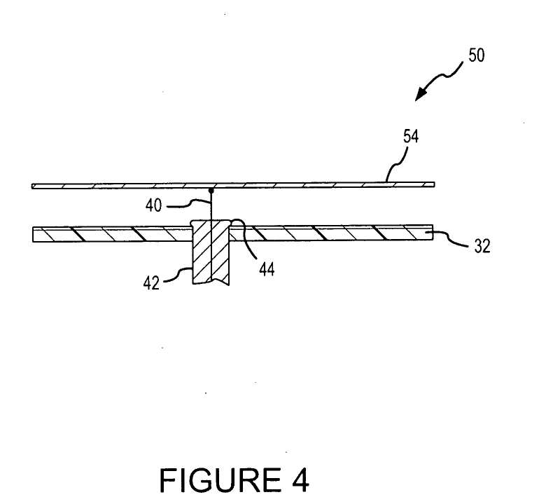

### DETAILED DESCRIPTION OF THE INVENTION

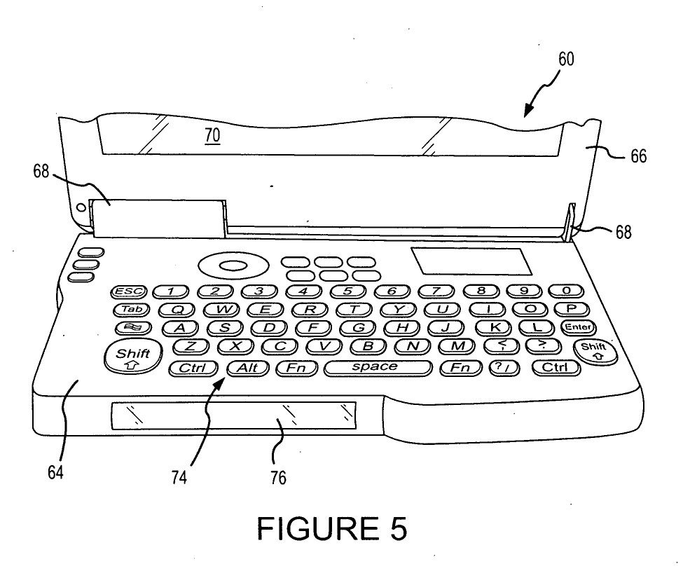

A handheld portable computer 60 using one example of an antenna according to the present invention is shown in FIG. 5. The computer 60 consists of a two-part clamshell case having a lower housing 64 to which a lid 66 is pivotally mounted through hinges 68. The lid 66 houses a display 70, which is visible on the inner surface of the lid 66. The lower housing 64 typically contains most of the circuitry (not shown) for the computer 60, and this circuitry is generally mounted on printed circuit boards (not shown). A keyboard 74 is mounted on the upper surface of the lower housing 64. The portable computer 60 also includes a wireless transceiver (not shown) mounted in the lower housing 64 to provide the computer with wireless communication capabilities.

In the handheld portable computer 60, both the lower housing 64 and the lid 66 are formed from sheets of a conductive metal such as magnesium. As a result, the wireless transceiver cannot use an internal antenna as is typically used in conventional portable computers and other portable electronic devices like PDA's. The wireless transceiver could be connected to an externally mounted antenna, but doing so would require an undesirable increase in the dimensions of the computer 60. Furthermore, since most of the RF energy would be radiated by a printed circuit board used as the ground plane for the antenna, most of the RF energy would remain inside the lower housing 64. The handheld computer 60 solves these problems while providing good performance by forming a recess (not shown in FIG. 5) in the lower housing 64, mounting a three-element planar antenna (not shown in FIG. 5) in the recess, and covering the recess with a window 76 that is substantially transparent to RF energy. As a result, the computer 60 retains its compact configuration.

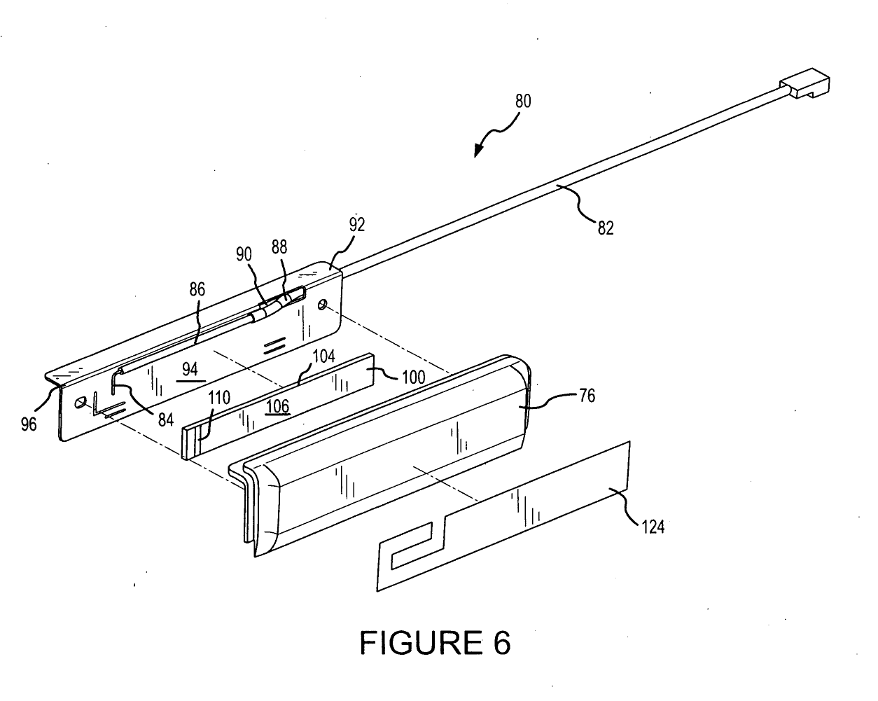

The components of one example of an antenna 80 used in the handheld portable computer 60 are shown in greater detail in FIGS. 6-8. With reference first to FIG. 6, the antenna 80 is connected to a transceiver (not shown) by a coaxial cable 82 having a center conductor 84 and a braided conductive shield 86. The shield 86 may be covered by an insulative layer 88. The coaxial cable 82 extends through a slot 90 in a conductive plate 92 and then runs along a surface 94 of the plate 92 for a substantial distance, such as one-quarter wavelength at the operating frequency of the transceiver. The plate 92 either forms the inside surface of the recess, or it may be attached to a surface of the lower housing 64 within the recess. The surface 94 of the plate 92 faces outwardly, and the upper edge of the plate 92 is bent inwardly at 96 (FIG. 6).

The insulative layer 88 is removed from the shield 86 of the coaxial cable 82 as it extends along the surface 94 of the plate 92. As a result, the shield 86 is exposed, and this exposed portion of the shield 86 is connected to the plate 92, such as by soldering. The length of the portion of the shield 86 that is connected to the plate 92 is preferably at least one-quarter of a wavelength at the operating frequency of the antenna 80. Current leakage from the shield 86, which occurs because of the unequal current density in the shield 86 and center conductor 84, is thereby transferred to the plate 92, and from the plate 92 to the lower housing 64. The current transferred to the lower housing 64 causes the housing 64 to radiate RF energy in the same manner that a printed circuit board radiates RF energy in a conventional antenna mounted within a non-conductive housing.

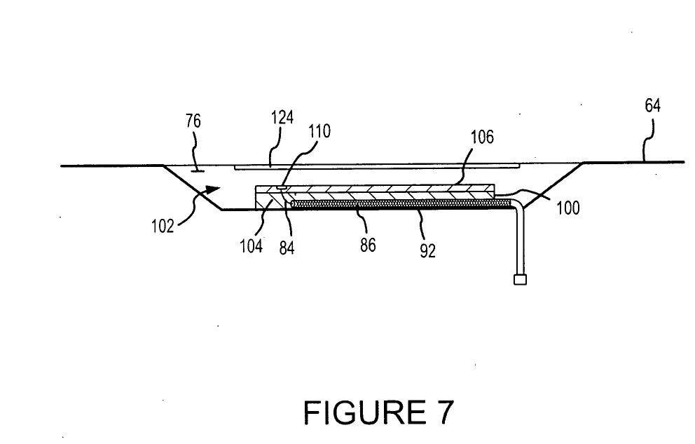

A piece of printed circuit board 100 is placed on the surface 94 of the plate 92. The circuit board 100 is shown as being rectangular, but it alternatively could have other shapes. FIG. 7 shows the plate 92 and printed circuit board 100 positioned within a recess 102 in the lower housing 64. The printed circuit board 100 has a core 104 of a dielectric material, and a conductive layer 106 covering at least one of its surfaces. The surface of the dielectric core 104 may also be covered with a conductive layer (not shown), but this is not necessary and is not used in the antenna 80 shown in FIGS. 6-8. The length of the printed circuit board 100 is one-half wavelength at the operating frequency of the transceiver (not shown) to which it is coupled. A slot 110 is formed in the conductive layer 106 at a location where the impedance between the plate 92 and the conductive layer 106 is a predetermined value, such as 50 ohms. The center conductor 84 of the coaxial cable 82 is connected to the conductive layer 106 at the slot 110, such as by soldering the conductor 84 within the slot 110.

When an RF signal is applied to the coaxial cable 82, the conductive layer 106, as well as the plate 92 and lower housing 64, acts as a driven element and will thus radiate RF energy. However, the performance would be less than ideal because the conductive layer 106 of the printed circuit board 100 is recessed so deeply within the lower housing 64. To alleviate this problem, the recess 102 is covered with the window 76 as shown in FIG. 5. In one example of the antenna 80, the window 76 is formed by a material that is substantially transparent to RF energy. A parasitic radiating element 124 may be mounted in or on the window 76. The radiating element 124 may be formed of a conductive material that is either embedded within the window 76 or mounted on either surface of the window 76. Alternatively, the parasitic radiating window may be formed by conductive paint or other material applied to a surface of the window 76. The length of the parasitic radiating element 124 is preferably about one-half a wavelength at the operating frequency of the antenna 80. Although the antenna 80 shown in FIGS. 6-8 uses the parasitic radiating element 124, it should be understood that the parasitic radiating element 124 is not necessary, and, in an alternative example of the antenna 80, the parasitic radiating element 124 is not mounted on or within the window 76.

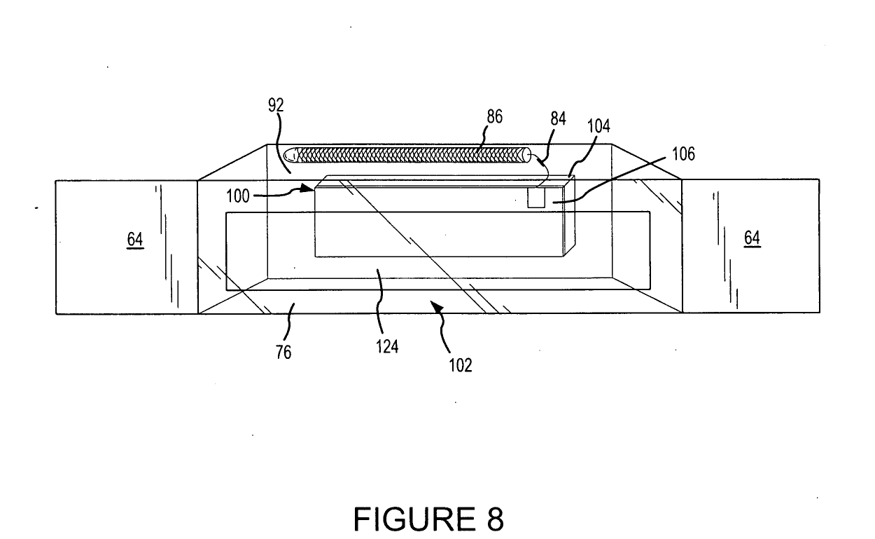

The manner in which the plate 92, coaxial cable 82, and printed circuit board 100 fit within the recess 102 and are enclosed by the window 76 and radiating element 124 is best shown in FIG. 8. In one example of the antenna 80, the recess 102 has a depth of about 0.14 inches, the printed circuit board 100 has a thickness of about 0.06 inches, the radiating element 124 is positioned from the printed circuit board 100 by a distance of about 0.08 inches, and the window 76 is about 0.04 inches thick.

In operation, RF energy radiated by the driven element formed by the conductive layer 106 of the printed circuit board 100 is capacitively coupled to the radiating element 124. The radiating element 124 then radiates the RF energy outside the housing 64. By being located on the outer periphery of the housing 64, the RF energy emitted by the radiating element 124 is not adversely affected by the conductive material forming the housing 64. As explained above, a substantial amount of RF energy is also radiated by the housing 64 itself since RF current is transferred from the shield 86 of the coaxial cable 82 to the housing 64.

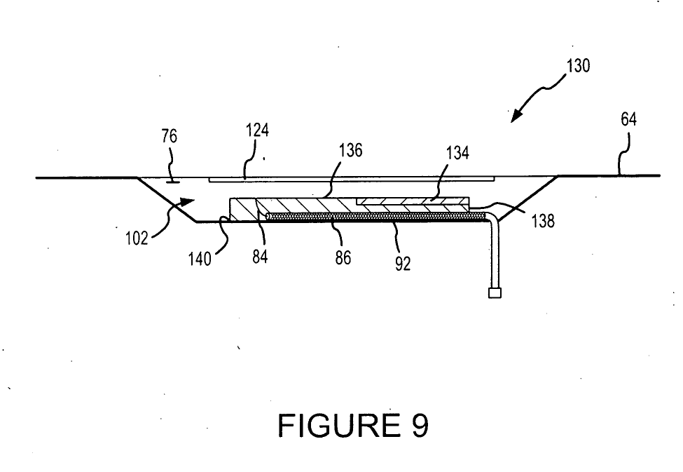

An alternative example of an antenna 130 according to the invention is shown in FIG. 9. The antenna 130 uses most of the same components that are used in the antenna 80 of FIGS. 6-8. Therefore, in the interest of brevity, a description of their structure and operation will not be repeated. The antenna 130 differs from the antenna 80 by using a driven element in the form of a printed circuit board 134 having a length of one-quarter wavelength, and by extending a conductive layer 136 of the board 134 beyond the edge of a dielectric core 138. The extending edge of the conductive layer 136 is then connected to the plate 92 at 140. The center conductor 84 of the coaxial cable 82 is then connected to the conductive layer 136 at a location where the impedance between the conductive layer 136 and the plate 92 is a predetermined value, such as 50 ohms. The antenna 130 is thus a true planar inverted F antenna (“PIFA”).

The antenna 130 operates in substantially the same manner as the antenna 80 with the RF energy being capacitively coupled to the radiating element 124, and the radiating element 124 and the housing 64 radiating RF energy.

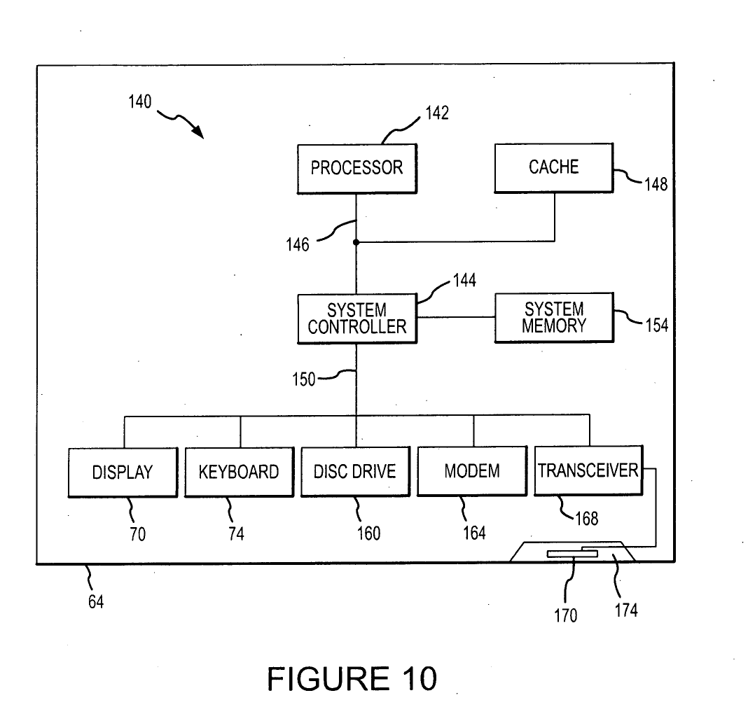

A block diagram of the computer 60 is shown in FIG. 10. The computer 60 includes conventional or hereinafter developed computer circuitry 140, which is enclosed within the housing 64. The computer circuitry 140 may include a processor 142 coupled to a system controller 144 through a processor bus 146. A cache memory unit 148, which is typically implemented with static random access memory (“SRAM”), is also coupled to the processor 142 through the processor bus 146. The system controller 144 serves as a communications bridge between the processor 142 and an expansion bus, such a peripheral component interface (“PCI”) bus 150. The system controller 144 also serves as a communication path between the processor 142 and system memory 154, which is typically dynamic random access memory (“DRAM”).

A variety of peripheral devices are coupled to the PCI bus 150, including the display 70 (FIG. 5), the keyboard 74, a mass storage device such as a disc drive 160, a modem 164, and a wireless transceiver 168. The wireless transceiver 168 is connected to an antenna 170, which may be the antenna 80, the antenna 130, or some other example of the inventive antenna. As shown in FIG. 10, the antenna 170 is placed in a recess 174 formed in the housing 64.

In an alternative embodiment, the computer 60 uses the computer circuitry shown and described in U.S. patent application Ser. No. 10/871,871 entitled PORTABLE ELECTRONIC DEVICE WITH REMOVABLE MODULE HAVING HIGH AND LOW POWER PROCESSORS OPERABLE IN A LOW POWER MODE and filed Jun. 17, 2004, which is incorporated herein by reference.

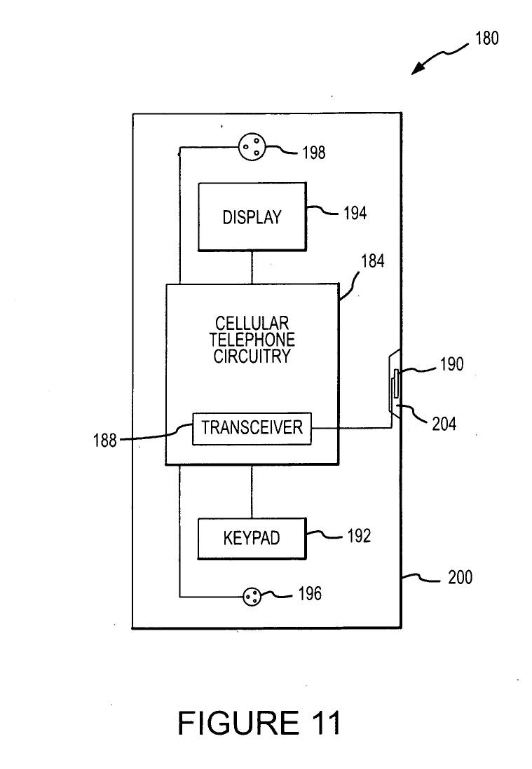

As mentioned above, various examples of the inventive antenna can be used in electronic devices other than portable computers. For example, they may be used in a cellular telephone, such as a cellular telephone 180 shown in FIG. 11. The cellular telephone 180 includes conventional or hereinafter developed cellular telephone circuitry 184, which includes a wireless transceiver 188. The wireless transceiver 188 is connected to an antenna 190, which again may be the antenna 80, the antenna 130, or some other example of the inventive antenna. The cellular telephone circuitry 184 is also connected to a keypad 192, a display 194, a microphone 196, and a loudspeaker 198. The cellular telephone 180 has a conductive housing 200 enclosing the cellular telephone circuitry 184 and transceiver 188. Again, the antenna 190 is mounted in a recess 204, as explained above.

Although the present invention has been described with reference to the disclosed embodiments, persons skilled in the art will recognize that changes may be made in form and detail without departing from the spirit and scope of the invention. For example, although various examples of the inventive antenna are shown and explained in the context of a hand-held computer or cellular telephone, it will be understood that various examples of the inventive antenna can be included in a wide variety of other devices, both portable and fixed. Typical examples might be notebook computers and PDA's, to name a few. Such modifications are well within the skill of those ordinarily skilled in the art. Accordingly, the invention is not limited except as by the appended claims.

We claim:

1. An antenna, comprising:
a planar conductive ground plane;
a driven element positioned along a surface of the ground plane;
a coaxial cable extending along the ground plane, the coaxial cable having a shield connected to the ground plane along at least some of the portion of the coaxial cable extending along the ground plane, the coaxial cable having a center conductor connected to the driven element; and
a conductive radiating element positioned at a location spaced from the driven element so that RF energy coupled to the driven element is capacitively coupled to the radiating element.

2. The antenna of claim 1 wherein the driven element comprises a rectangular printed circuit board having a dielectric core and conductive material coating a surface of the dielectric core facing away from the ground plane, the center conductor of the coaxial cable being connected to the conductive material.

3. The antenna of claim 2 wherein the printed circuit board has a length that is approximately one-half of the wavelength at an operating frequency of the antenna.

4. The antenna of claim 2 wherein the conductive material coating the dielectric core is connected to the ground plane at one end edge, and wherein the printed circuit board has a length that is approximately one-quarter of the wavelength at an operating frequency of an the antenna.

5. The antenna of claim 2 wherein the center conductor of the coaxial cable is connected to the conductive material at a location spaced from one end of the rectangular printed circuit board.

6. The antenna of claim 1 wherein the radiating element comprises a planar rectangular sheet of conductive material.

7. The antenna of claim 6 wherein the rectangular sheet of conductive material has a length that is greater than the length of the driven element.

8. The antenna of claim 1 wherein the ground plane and driven element are positioned behind a window that is transparent to RF energy, and wherein the conductive radiating element comprises a layer of conductive paint coating a surface of the window.

9. The antenna of claim 1 wherein the driven element is spaced from the radiating element by a distance that is substantially less than one-quarter wavelength at an operating frequency of the antenna.

10. The antenna of claim 1 wherein the shield is connected to an external surface of the planar conductive ground plane.

11. An antenna, comprising:
a planar conductive ground plane;
a driven element positioned along a surface of the ground plane; and
a coaxial cable extending along the ground plane, the coaxial cable having a shield connected to the ground plane along at least some of the portion of the coaxial cable extending along the ground plane, the coaxial cable having a center conductor connected to the driven element.

12. The antenna of claim 11 wherein the driven element comprises a rectangular printed circuit board having a dielectric core and conductive material coating a surface of the dielectric core facing away from the ground plane, the center conductor of the coaxial cable being connected to the conductive material.

13. The antenna of claim 12 wherein the printed circuit board has a length that is approximately one-half of the wavelength at an operating frequency of the antenna.

14. The antenna of claim 12 wherein the conductive material coating the dielectric core is connected to the ground plane at one end edge, and wherein the printed circuit board has a length that is approximately one-quarter of the wavelength at an operating frequency of an the antenna.

15. The antenna of claim 12 wherein the center conductor of the coaxial cable is connected to the conductive material at a location spaced from one end of the rectangular printed circuit board.

16. The antenna of claim 11 wherein the radiating element comprises a planar rectangular sheet of conductive material.

17. The antenna of claim 16 wherein the rectangular sheet of conductive material has a length that is greater than the length of the driven element.

18. The antenna of claim 11 wherein the ground plane and driven element are positioned behind a window that is transparent to RF energy.

19. The antenna of claim 1 wherein the shield is connected to an external surface of the planar conductive ground plane.

20. A portable electronic device, comprising:
electronic circuitry for implementing a function performed by the portable electronic device, the electronic circuitry including a radio transceiver;
a conductive metal housing surrounding the electronic circuitry, including the radio transceiver, the conductive metal housing having a recess formed therein along at least one surface of the housing, the recess having a conductive inner wall and four side walls;
a driven element positioned along the inner wall of the recess;
a coaxial cable connected to the radio transceiver, the coaxial cable entering the recess and extending along a conductive wall of the recess, the coaxial cable having a shield connected to the conductive wall of the recess along at least some of the portion of the coaxial cable extending along the conductive wall of the recess, the coaxial cable having a center conductor connected to the driven element;
a planar window enclosing the recess, including the driven element and the coaxial cable, the planar window being fabricated of a material that is transparent to RF energy; and
a conductive radiating element carried by the planar window, the conductive radiating element being positioned so that RF energy coupled to the driven element is capacitively coupled to the radiating element.

21. The portable electronic device of claim 20 wherein the driven element comprises a rectangular printed circuit board having a dielectric core and conductive material coating a surface of the dielectric core facing away from the inner wall of the recess, the center conductor of the coaxial cable being connected to the conductive material.

22. The portable electronic device of claim 21 wherein the printed circuit board has a length that is approximately one-half of the wavelength at the operating frequency of the radio transceiver.

23. The portable electronic device of claim 21 wherein the conductive material coating the dielectric core is connected to the inner wall of the recess at one end edge, and wherein the printed circuit board has a length that is approximately one-quarter of the wavelength at the operating frequency of the radio transceiver.

24. The portable electronic device of claim 21 wherein the center conductor of the coaxial cable is connected to the conductive material at a location spaced from one end of the rectangular printed circuit board.

25. The portable electronic device of claim 20 wherein the conductive radiating element is bonded to an outer surface of the planar window.

26. The portable electronic device of claim 20 wherein the conductive radiating element is embedded in the planar window.

27. The portable electronic device of claim 20 wherein the conductive radiating element comprises a layer of conductive paint coating a surface of the planar window.

28. The portable electronic device of claim 20 wherein all of the side walls of the recess are of a conductive metal.

29. The portable electronic device of claim 20 wherein the shield of the coaxial cable extends along and is connected to the inner wall of the recess.

30. The portable electronic device of claim 20 wherein the radiating element comprises a planar rectangular sheet of conductive material.

31. The portable electronic device of claim 30 wherein the rectangular sheet of conductive material has a length that is greater than the length of the driven element.

32. The portable electronic device of claim 20 wherein the driven element is spaced from the radiating element by a distance that is substantially less than one-quarter wavelength at the operating frequency of the radio transceiver.

33. The portable electronic device of claim 20 wherein an outer surface of the planar window is substantially flush with an outer surface of the conductive housing adjacent the planar window

34. The portable electronic device of claim 20 wherein the electronic circuitry comprises computer circuitry.

35. The portable electronic device of claim 20 wherein the shield is connected to an external surface of the conductive wall of the recess.

36. A portable computer, comprising:
a display;
a keyboard;
computer circuitry comprising a processor, a radio transceiver, and a bus bridge coupling the display, keyboard and radio transceiver to the processor;
a conductive metal housing surrounding the computer circuitry, including the radio transceiver, the conductive metal housing carrying the display and the keyboard on respective surfaces and having a recess formed therein along at least one surface of the housing, the recess having a conductive inner wall and four side walls;
a driven element positioned along the inner wall of the recess;
a coaxial cable connected to the radio transceiver, the coaxial cable entering the recess and extending along a conductive wall of the recess, the coaxial cable having a shield connected to the conductive wall of the recess along at least some of the portion of the coaxial cable extending along the conductive wall of the recess, the coaxial cable having a center conductor connected to the driven element;
a planar window enclosing the recess, including the driven element and the coaxial cable, the planar window being fabricated of a material that is transparent to RF energy; and
a conductive radiating element carried by the planar window, the conductive radiating element being positioned so that RF energy coupled to the driven element is capacitively coupled to the radiating element.

37. The portable computer of claim 36 wherein the driven element comprises a rectangular printed circuit board having a dielectric core and conductive material coating a surface of the dielectric core facing away from the inner wall of the recess, the center conductor of the coaxial cable being connected to the conductive material.

38. The portable computer of claim 37 wherein the printed circuit board has a length that is approximately one-half of the wavelength at the operating frequency of the radio transceiver.

39. The portable computer of claim 37 wherein the conductive material coating the dielectric core is connected to the inner wall of the recess at one end edge, and wherein the printed circuit board has a length that is approximately one-quarter of the wavelength at the operating frequency of the radio transceiver.

40. The portable computer of claim 37 wherein the center conductor of the coaxial cable is connected to the conductive material at a location spaced from one end of the rectangular printed circuit board.

41. The portable computer of claim 36 wherein the conductive radiating element is bonded to an outer surface of the planar window.

42. The portable computer of claim 36 wherein the conductive radiating element is embedded in the planar window.

43. The portable computer of claim 36 wherein all of the side walls of the recess are of a conductive metal.

44. The portable computer of claim 36 wherein the shield of the coaxial cable extends along and is connected to the inner wall of the recess.

45. The portable computer of claim 36 wherein the radiating element comprises a planar rectangular sheet of conductive material.

46. The portable computer of claim 45 wherein the rectangular sheet of conductive material has a length that is greater than the length of the driven element.

47. The portable computer of claim 36 wherein the conductive radiating element comprises a layer of conductive paint coating a surface of the planar window.

48. The portable computer of claim 36 wherein the driven element is spaced from the radiating element by a distance that is substantially less than one-quarter wavelength at the operating frequency of the radio transceiver.

49. The portable computer of claim 36 wherein an outer surface of the planar window is substantially flush with an outer surface of the conductive housing adjacent the planar window

50. The portable computer of claim 36 wherein the computer comprises a hand-held battery-powered portable computer.

51. The portable computer of claim 36 wherein the shield is connected to an external surface of the conductive wall of the recess.

52. A cellular telephone, comprising:
cellular telephone circuitry comprising at least a radio transceiver;
a conductive metal housing surrounding the cellular telephone circuitry, including the radio transceiver, the conductive metal housing having a recess formed therein along at least one surface of the housing, the recess having a conductive inner wall and four side walls;
a driven element positioned along the inner wall of the recess;
a coaxial cable connected to the radio transceiver, the coaxial cable entering the recess and extending along a conductive wall of the recess, the coaxial cable having a shield connected to the conductive wall of the recess along at least some of the portion of the coaxial cable extending along the conductive wall of the recess, the coaxial cable having a center conductor connected to the driven element;
a planar window enclosing the recess, including the driven element and the coaxial cable, the planar window being fabricated of a material that is transparent to RF energy; and
a conductive radiating element carried by the planar window, the conductive radiating element being positioned so that RF energy coupled to the driven element is capacitively coupled to the radiating element.

53. The cellular telephone of claim 52 wherein the driven element comprises a rectangular printed circuit board having a dielectric core and conductive material coating a surface of the dielectric core facing away from the inner wall of the recess, the center conductor of the coaxial cable being connected to the conductive material.

54. The cellular telephone of claim 53 wherein the printed circuit board has a length that is approximately one-half of the wavelength at the operating frequency of the radio transceiver.

55. The cellular telephone of claim 53 wherein the conductive material coating the dielectric core is connected to the inner wall of the recess at one end edge, and wherein the printed circuit board has a length that is approximately one-quarter of the wavelength at the operating frequency of the radio transceiver.

56. The cellular telephone of claim 53 wherein the center conductor of the coaxial cable is connected to the conductive material at a location spaced from one end of the rectangular printed circuit board.

57. The cellular telephone of claim 52 wherein the conductive radiating element is bonded to an outer surface of the planar window.

58. The cellular telephone of claim 52 wherein all of the side walls of the recess are of a conductive metal.

59. The cellular telephone of claim 52 wherein the shield of the coaxial cable extends along and is connected to the inner wall of the recess.

60. The cellular telephone of claim 52 wherein the radiating element comprises a planar rectangular sheet of conductive material.

61. The cellular telephone of claim 52 wherein the driven element is spaced from the radiating element by a distance that is substantially less than one-quarter wavelength at the operating frequency of the radio transceiver.

62. The cellular telephone of claim 52 wherein the conductive radiating element comprises a layer of conductive paint coating a surface of the planar window.

63. The cellular telephone of claim 52 wherein an outer surface of the planar window is substantially flush with an outer surface of the conductive housing adjacent the planar window

64. The cellular telephone of claim 52 wherein the shield is connected to an external surface of the conductive wall of the recess.

65. A method of transmitting and receiving radio-frequency (“RF”) energy from a transceiver, the method comprising:
coupling an RF signal to or from a driven element so that the driven element provides or receives, respectively, RF energy;
capacitively coupling the RF energy coupled from the driven element to a radiating element and the RF energy to the driven element from the radiating element; and
allowing the RF energy to be coupled to and from the radiating element.

66. The method of claim 65 wherein the driven element is positioned adjacent a ground plane, and wherein the act of coupling the RF signal to or from the driven element comprises coupling the RF signal between the driven element and the ground plane.

67. The method of claim 66 wherein the act of coupling the RF signal between the driven element and the ground plane comprises coupling the RF signal between the driven element and the ground plane along a substantial length of the ground plane.

68. The method of claim 65 wherein the driven element is spaced from the radiating element by a distance that is substantially less than one-quarter wavelength of the RF energy.
